(19) United States
(12) Patent Application Publication
(10) Pub. No.: US 2007/0239587 A1
(43) Pub. Date: Oct. 11, 2007

(54) System and Method For Dynamically Utilizing and Managing Financial, Operational, and Compliance Data

(75) Inventors: Alexander Tsigutkin, New York, NY (US); Vladimir Etkin, Fair Lawn, NJ (US)

Correspondence Address: EDWARD ETKIN, ESQ., Law Office of Edward Etkin, PC, 228 West End Avenue, Suite A, Brooklyn, NY, 11235, US

(73) Assignee: AXIOM SOFTWARE LABORATORIES, INC., New York, NY (US)

(21) Appl. No.: 11/733,186

(22) Filed: Apr. 9, 2007

Related U.S. Application Data
(60) Provisional application No. 60/790,518, filed on Apr. 7, 2006.

(51) Int. Cl. G06Q 40/00

(52) U.S. Cl. 705/36 R

(57) ABSTRACT

The inventive system and method provide an integrated data management platform implemented in four stages: Stage one is data collection, in which the novel system and method interface with, and collect data from multiple data sources and organize the collected data in accordance with user-defined criteria. Stage two is organization, in which the novel system and method link at least a portion of the data sources with at least one corresponding data model, such that each data model is representative of at least a portion of the data collectable from the at least one corresponding data source, and in which a portfolio is formed by applying at least one predefined visual business rule to a predetermined set of data models to manage data extracted from the data sources corresponding to the set of data models, to define and manage business logic, and to consolidate and categorize the data into at least one predetermined hierarchy. Stage three is performing aggregations and selectively performing aggregations on the portfolio obtained at Stage two. Finally, Stage four is analysis and reporting, in which the novel system and method provide analysis of the portfolio in accordance with at least one predetermined analysis protocol, and generate at least one report representative of the analysis.

### FIELD OF THE INVENTION

The present invention relates generally to a data processing system and method for dynamic data integration and data management infrastructure, and more particularly to a data processing system for Risk Management, Financial Reporting Transparency, Regulatory Compliance, Capital at Risk and Performance Measurement involving diverse data integration and management challenges.

### BACKGROUND OF THE INVENTION

In recent years the complex disciplines of Risk Management, Financial Reporting Transparency, Regulatory Compliance, Capital Allocation and Performance Measurement have emerged as key strategic drivers for the industry leading organizations' decision making. These resulted in a huge surge in demand for dynamic data integration and data management solutions. With each new data management requirement, the software industry usually responds with a stand-alone tool to address it. The problem with this approach is that the tools then need to be integrated into the organization's existing business environment, usually without any business context.

In response. Axiom Software Laboratories (AxiomSL) has developed a groundbreaking integrated platform consisting of three products, IntegrationCenter™, FinETL™ and Dynamic Data Warehouse™, that dramatically improves the complex data integration and management challenges facing organizations on the way to centralizing their strategic intelligence, knowledge base and business rules. The genius of Axiom SL's integrated platform is in its ability to interface non-intrusively with all upstream and downstream systems, as well as creation and use of Visual Business Rules™ to empower Business and IT professionals with a means of communicating business intelligence and organizational requirements. No other decision support platform delivers this competitive advantage.

### BRIEF DESCRIPTION OF THE DRAWINGS

In the drawings, wherein like reference characters denote corresponding or similar elements throughout the various figures:

FIG. 1 shows a block diagram of a first embodiment of the inventive system and method implemented as a four step integrated data management platform;

FIG. 2 shows am exemplary screen diagram of a first embodiment of a Business Rules manager sub-system of the novel integrated data management platform of FIG. 1.

FIG. 3 shows an exemplary screen diagram of the aggregation functions of a novel IntegrationCenter sub-system of the novel integrated data management platform of FIG. 1; and

FIG. 4 shows an exemplary screen diagram of an embodiment of implementation of FinETL, a graphical tool for data management and analytical process sub-system sub-system of the novel integrated data management platform of FIG. 1, shown as performing an exemplary profit and loss calculation and a rules-based analysis of financial statements.

### SUMMARY

Responding to a market need for an integrated platform as opposed to stand-alone tools, Axiom SL developed a suite of three products, IntegrationCenter™, FinETL™, and Dynamic Data Warehouse™, that are naturally integrated with each other and interface non-intrusively with other upstream and downstream systems. This unique platform integrates and executes a wide range of best of breed functions that have been proven to significantly reduce the time, frustration and resource requirements involved with data integration and data management.

IntegrationCenter™ provides a dynamic data management and modeling platform enabling transparent data access and delivery to and from business applications, while hiding complexities of existing systems. The novel system is equipped with a full process monitoring and workflow management, making it possible to rapidly automate even the most complicated process. Preserving years of IT investment, the solution easily adapts to business and technology changes inevitably facing each organization.

FinETL™, a graphical development environment, serves as both a pre- and post-data processing utility and allows not only the creation of sophisticated data transformation, validation, and cleansing flow, but also includes analytical capabilities such as pricing, risk calculations, P&L, cash-flow calculations, netting, aggregations, and so forth. FinETL is deployed with extensive set of functions, users can also create their own FinETL building blocks or components, as well as wrap around internally developed functions.

Visual Business Rules™ is an intelligent hierarchy management tool empowering IT and Business communities with a common insight for business logic and information analysis such as portfolio construction, report logic definition, multi-level hierarchies, netting rules, etc.

Dynamic Data Warehouse™ provides storage and easy access for data from all front, middle, back office and accounting systems, as well as market data (historical prices, volatilities, correlations, yield curves, credit ratings and migration probabilities). Coverage also incorporates global and company specific reference data (security and customer masters, settlement, etc.) as well as operational data (loss data, causes, KRI, etc.). Unique function of DDW is to store results of analytical calculations and reports.

Data maintenance and administration functions offer data quality control and adjustments, accumulation and archiving, status reporting, sophisticated data and application security, etc. Axiom SL's Dynamic Data Warehouse can also supplement any data requirements within existing data warehouses.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

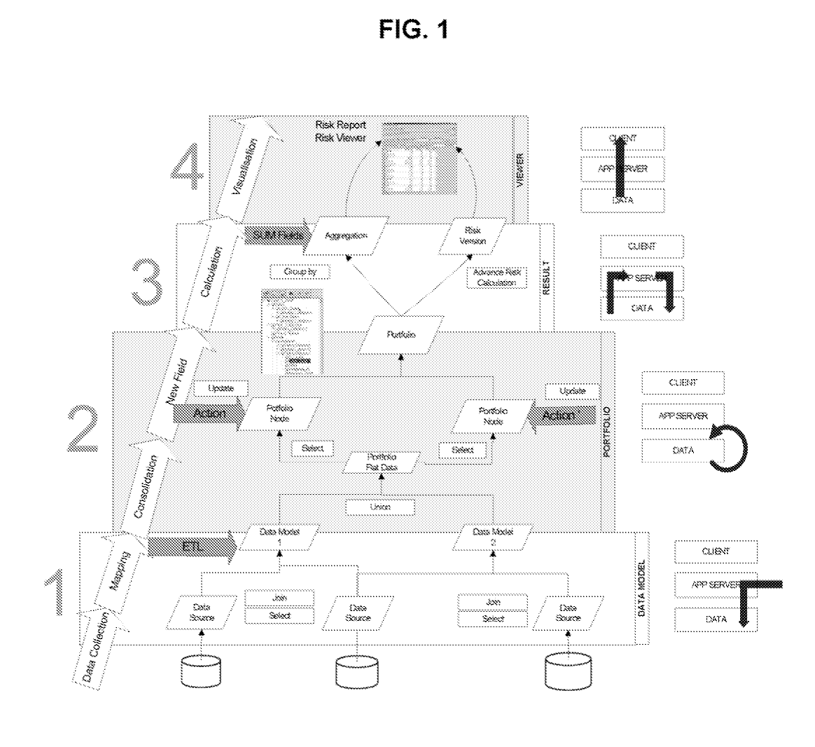

As shown in FIG. 1, the system and method involved with Axiom SL's integrated data management platform consists of four steps: Step one is data collection; Step two is organization; Step three is aggregation and calculations; Step four is analysis and reporting. The end result is dramatically improved data management and enhanced decision making capabilities—ensuring the right information to the right people at the right time.

Following is a detailed description of each step involved in Axiom SL's integrated data management process.

Step one: involves interfacing and data collection from multiple sources such as transaction, reference (security master, customer data, GL), market data: credit and operational loss events information. It also covers automated loaders and manually captured information needed. AxiomSL's IntegrationCenter easily connects to source systems and registers data for physical storage or virtual access.

Using AxiomSL's Dynamic Data Modeling capability the sources are linked into data models or extended with additional information defined by business rules. At this stage, automated analysis of source data for completeness and/or accuracy is achieved with tools that allow for either user-defined data quality rules, default values to be entered for missing or ‘wrong’ data, or for human intervention to correct reported deficiencies. AxiomSL's FinETL performs these functions easily with a seamless, tight metadata connection to IntegrationCenter and Dynamic Data Warehouse.

Step two: involves organizing or extracting the content of data sources according to user-defined criteria. Without programming, Axiom SL's Visual Business Rules (VBR) are used to define and manage business logic to consolidate and categorize content into many different hierarchies. Visual Business Rules also perform conditional actions that extend the source data with additional values or required calculations needed for downstream functions.

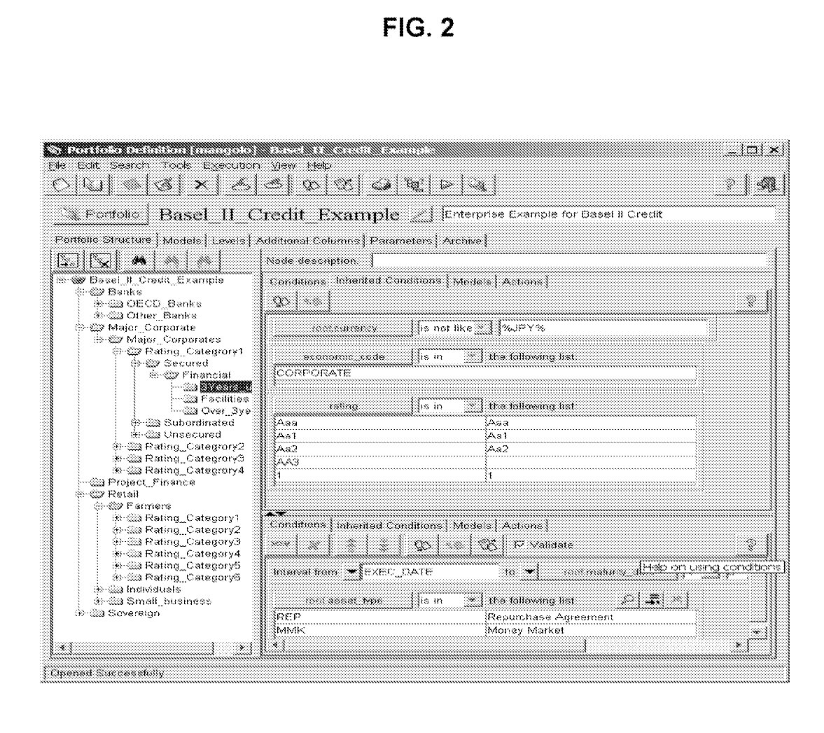

The benefit of VBR is that the same data sources can be used repeatedly for different requirements without the need to replicate them. This provides a transparent environment that easily shows the rules used and their effects on the resulting consolidated data model (or ‘portfolio’ in AxiomSL's terminology). FIG. 2 shows an example of the Visual Business Rules manager.

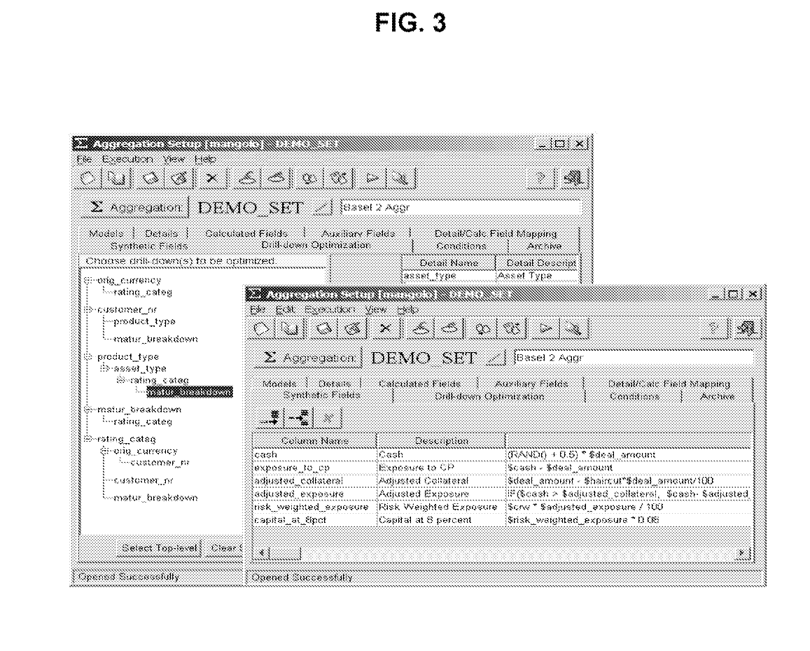

Step three: involves performing aggregations and additional calculations on the portfolio. The calculations may be based on client proprietary analytical applications, third-party's or AxiomSL's analytical capability. FIG. 3 is an example of the aggregation functions of IntegrationCenter. They comprise the categories of aggregation, including portfolio and other characteristics, the measures to be aggregated; the drill-down structure and any additional calculations needed on the aggregated totals.

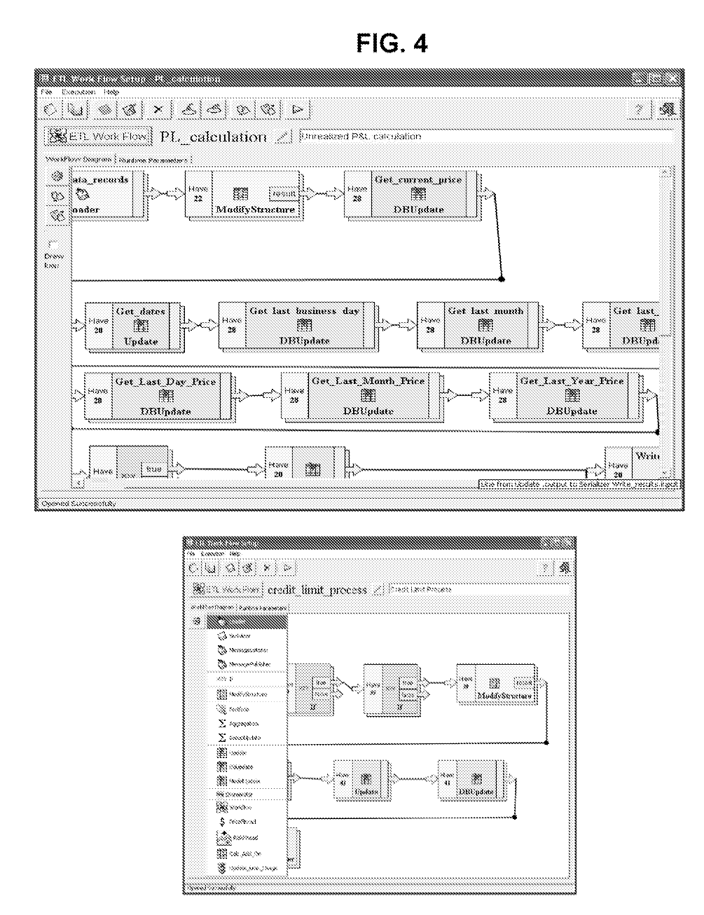

This stage includes more complex tasks that require seamless integration of the source and results data to another application. FIG. 4 shows examples of how AxiomSL's FinETL, a graphical tool for data management and analytical process design performs a P&L calculation and a rules-based analysis of financial statements.

In the second example, using the results of the analysis, FinETL then performs a risk limit measurement based on user-defined rules, which are then passed to a limit management system. IntegrationCenter automatically stores the results in the Dynamic Data Warehouse for transparent analysis. Alternatively, results can also be ‘published’ to an external storage environment.

Step four: includes analysis, report generation and distribution. It involves results visualization together with drill-down analysis down to the source level. IntegrationCenter integrates its native report writing capability for easy use by business or IT professionals and links it to the Dynamic Data Warehouse. It can also interface with external reporting tools. IntegrationCenter's report-writer has both tabular ad-hoc style reporting and free-form reports used for designing specific reports with graphics for senior management, electronic submission and results validation.

Wrapped around these four steps is a graphical workflow process management tool (FIG. 4) that sequences, schedules and monitors these processes to control how a ‘job’ is completed. IntegrationCenter includes these functions to improve operating efficiencies and to provide control, process transparency and easy audit trails.

Using Axiom SL's integrated platform, clients are able to achieve the following Data integration and management scenarios:

Interfacing, capturing, cataloging and storing data time series and market data from multiple sources.

Aggregating balance sheet information from hundreds of despaired sources of information by applying Visual Business Rules directly against original source data structures.

Referencing data management, including security masters and customer information consolidation, quality, for pricing and portfolio construction.

Analyzing credit and operational risk events and severity for Basel II regulatory compliance and economic capital measurement inputs (PD—Probability of Defaults, LGD—Loss Given Defaults, EAD—Exposure At Defaults, Loss Events, etc).

Organizing transactional data sources into portfolio hierarchies for transparency and audit trails related to financial and regulatory reporting, compliance monitoring and risk management.

Data integrity/quality monitoring, reporting and cleansing for multiple business applications and reporting.

Achieving compliance with Sarbanes-Oxley Act, new FASB/IAS rules and Basel II at faster speed-to-market and lower costs.

Benefits

The extraordinary value of AxiomSL's integrated platform to business organizations is its unique ability to work with all the components of existing enterprise applications. While stand-alone data management products perform many of these functions, some may even be called “Best of Breed”, none of them understand the existence of other upstream or downstream data management functions. Axiom SL's technology integrates non-intrusively thereby significantly decreasing the large integration investments in money, people and time that stand-alone products require.

Axiom SL's technology has fundamentally changed how organizations centralize their strategic intelligence and knowledge base. On a daily basis, it greatly enhances executives' decision-making capabilities across the board, offers faster speed to market at lower costs and improves shareholder's value.

The overall technical benefits of Axiom SL's integrated platform are proven and significant:

AxiomSL's products embrace an open technology and approach that fit any infrastructure and protect business application investments.
The data management functions of IntegrationCenter, FinETL and Dynamic Data Warehouse are complete and production-proven in complex analytical and decision support applications for sophisticated organizations.
They offer lower lifecycle costs of data integration and management.
They bring IT and business professionals together to collaborate in the data management solution of a business problem.
They provide a more controlled, transparent and auditable end-to-end management of source data into application results. Importantly, the data management functions of the integrated platform are comprehensive.
They are proven to address all of the data management challenges that arise in the most complex financial management requirements for some of the most sophisticated organizations.
   Axiom SL's IntegrationCenter has a proven track record of success as a data management platform for the following business applications:

Front-, middle- and back-office support systems

Reference and market data management applications

Enterprise Risk Management (ERM) (market, credit, liquidity, operational)

Sarbanes Oxley compliance

Hedge effectiveness under IAS and FAS 133 regulations

Basel II data collection and compliance

Asset/Liability Management (ALM)

Portfolio management

Financial control and management reporting

Regulatory reporting

Compliance, trade surveillance

The Importance of Technology

The key aspect of technology is component based architecture. Since Axiom SL technology is based on dynamic principles, at each level Client. Application Server and Database appropriate dynamic techniques were employed. While dynamic capabilities of the relational databases were available for quite some time, very few business applications and data warehouses were utilizing it. With the introduction of component based architecture and application server concepts Axiom SL has been using the newest technology to give Axiom products maximum flexibility, scalability and user friendliness.

The basic system configuration includes either a distributed or centralized database with a central location containing Meta data and external data references. Any ODBC-compliant database or combination of databases (e.g., Oracle, DB2, SQL Server, Sybase, etc.) may serve as a database engine.

Application server may operate in several modes:
CORBA interface
WEB services
   Axiom application server—set of factories which operate on virtually all types of operating systems (UNIX, Linux, or Windows)—can either be centralized or distributed among heterogeneous servers for greater scalability and performance.

Clients may either run stand-alone, via Java application, or by web browser on most operating systems.

Novel Aspects of AxiomSL technology

AxiomSL provides a novel data-centered and flexible software platform with interoperable componentized solutions that can dynamically address needs of the marketplace.

The concept to work with multiple despaired external data models and to have data modeling as a part of data management platform is unique to IntegrationCenter. Among IC's other distinctive aspects are:

Permits hiding of complexity of a data structure or relationship between data sources

Closes the gap between XML structures and relational data models

Makes it easier to integrate messaging with data warehousing

Carries relationships among the source data into analytical processes, applications, reporting, and auditing.

Extends input data models with results data which become, themselves, useable data sources

IC's FinETL module allows users to have a message (XML or not) or data warehouse on either end of the ETL process; e.g., transform message into DB, DB into message, message-message, or DB-DR.

IC's workflow module is process-centered, using data merely as a transporter of information, concentrating on business activities (load, aggregation, risk, report, etc.), while most competing products have only data-centered functionality, leaving much of the problems dealing with organization process unsolved.

IC is equipped with Visual Business Rules that enable business users to perform portfolio construction, counterparty hierarchies, compliance rules definition, and financial reporting. VBR does not require specific technology and database expertise.

IC reduces applications' dependence on specific data inputs and structures, enabling easy maintenance and conversion and minimizing total life cost of ownership.

IC functional modules can be deployed and positioned along with existing tools. For example, if ETL tools already exist. It still can be configured to perform its transformation capability, dynamic data modeling, workflow and warehousing functions.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For examples it is expressly intended that all combinations of those elements and/or method steps which perform substantially the same function in substantially the same way to achieve the same results are within the scope of the invention,

We claim:

1. A data processing method for managing data contained in, and/or generated by a plurality of data sources; comprising the steps of:
(a) interfacing and collecting the data from the plurality of data sources;
(b) organizing data collected from the plural data sources in accordance with a plurality of user-defined criteria;
(c) linking each of at least a portion of the data sources with at least one of a corresponding data model, such that each said plural data model is representative of at least a portion of the data collectable from at least one corresponding plural data source,
(d) forming a portfolio by applying at least one predefined visual business rule to a predetermined set of data models to manage data extracted from the plural data sources corresponding to said set of data models to define and manage business logic and to consolidate and categorize the data into at least one predetermined hierarchy;
(e) performing aggregations and selectively performing at least one additional calculation on said portfolio; and
(f) analyzing said portfolio in accordance with at least one predetermined analysis protocol, and generating at least one report representative of said analysis.
